(19) United States
(12) Patent Application Publication
(10) Pub. No.: US 2007/0054055 A1
(43) Pub. Date: Mar. 8, 2007

(54) Gloss paint and method for using the same

(75) Inventors: Bor-Yuan Hsiao, Tu-Cheng (TW); Chi-Chuang Ho, Tu-Cheng (TW); Chuan-De Huang, Tu-Cheng (TW); Sheng-Hsi Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/432,566

(22) Filed: May 10, 2006

(30) Foreign Application Priority Data
Sep. 5, 2005 (TW) 94130339

(51) Int. Cl. B05D 3/02; D06M 15/277

(52) U.S. Cl. 427/372.2; 427/421.1; 524/544; 524/356

(57) ABSTRACT

The present invention discloses a gloss paint, the gloss paint includes: a fluoro acryl-silicon resin in an amount by weight from 20% to 60%, pigment particles in an amount by weight from 5% to 40%, an additive in an amount by weight of less than 5%, the remainder being a solvent. The present invention also discloses a method for using the gloss paint to form a gloss paint layer on a surface of an article. In use, the gloss paint of the present invention can obtain a high gloss finish without a top coat. Thus the present gloss paint simplifies the steps and equipments of using the same, and economizes on the cost of the procedure.

### BACKGROUND

1. Technical Field

The present invention relates generally to paints, and more particularly to a paint composition with high gloss that can be applied to various products for improving appearance and performance thereof. The present invention also relates to a method for using the gloss paint.

2. Discussion of Related Art

Generally, a high gloss paint layer includes a priming coat and a top coat, where the priming coat directly adheres to a surface of an article or product. The priming coat is usually used for sealing the surface and providing color. The top coat is formed by applying a transparent paint or a metallic paint, which cooperates with the priming coat to take on a high gloss appearance.

Generally, a typical method for fabricating the above high gloss paint layer includes the following steps: firstly, treating the surface of the article or product; secondly, applying the priming coat onto the surface, and drying for 10 to 20 minutes at room temperature; thirdly, applying the transparent paint or the metallic paint onto the priming coat, and drying for 10 to 15 minutes at room temperature; finally, placing the article or product into an oven, and heating the article or product at 50 to 60 degrees centigrade for about 60 minutes, and thus obtaining the high gloss paint layer.

However, in the above method, the priming coat and top coat usually need be coated for twice or more times. As a result, the cost of the process is increased. In addition, the priming coat is generally formed by cathodic electrophoresis coating process. However, cathodic electrophoresis coating equipment is expensive.

Therefore, what is needed is to provide a paint which can give a high gloss finish whilst also being economical to use, and a method for using the same.

### SUMMARY

An embodiment of the present invention provides a gloss paint including: a fluoro acryl-silicon resin in an amount by weight from 20% to 60%, pigment particles in an amount by weight from 5% to 40%, an additive in an amount by weight of less than 5%, the remainder being a solvent.

Another embodiment of the present invention provides a method for using the gloss paint to form a gloss paint layer on a surface of an article, which includes the following steps: applying the above gloss paint on the surface of the article, and heating the gloss paint to evaporate the solvent, thereby forming a gloss paint layer.

Unlike conventional paint, the present gloss paint can obtain a paint layer with a high gloss finish without requiring an additional top coat, thereby economizing on equipment and material.

### DETAILED DESCRIPTION OF THE EMBODIMENTS

Reference will now be made to describe in detail the preferred embodiments of the present gloss paint and a method for using the same.

A gloss paint according to a first embodiment includes the following components: a fluoro acryl-silicon resin in an amount by weight from 20% to 60%, pigment particles in an amount by weight from 5% to 40%, an additive in an amount by weight of less than 5% and the remainder being a solvent.

The fluoro acryl-silicon resin may be represented by formula as below: 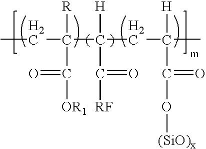
Wherein R and R₁ are C1-C4 alkyl, x is in the range from 1 to 3, and m is in the range from 83 to 277.

An average diameter of the pigment particles is in the range from about 10 nanometers to 500 nanometers. According to an aspect of the embodiment, the pigment particles with such diameter may be obtained by high-speed milling a common pigment.

The additive may be chosen from the group consisting of hardening agents, anti-skinning agents, plasticizers, or any appropriate combination thereof. The additive can promote some properties of the paint. For example, the anti-skinning is used to prevent the paint from forming a skin; the hardening agent is used to make the paint harden faster during drying; and the plasticizer is used to enhance toughness, avoid cracking and improve impact resistance. According to an aspect of the embodiment, the plasticizer is, for example, polyamide with low molecular weight. The anti-skinning agent may be methyl ethyl ketoxime. The hardening agent may be toluene diisocyanate.

The solvent is mainly used for dissolving the fluoro acryl-silicon resin, and may be chosen from the group consisting of dimethylbenzene, methyl ethyl ketone, methyl isobutyl ketone, or any appropriate combination of these compounds.

A method for making the gloss paint includes the following steps: firstly, providing a fluoro acryl-silicon resin in an amount by weight from 20% to 60%, pigment particles in an amount by weight from 5% to 40%, a additive in an amount by weight of less than 5%, and the remainder being a solvent; secondly, feeding the fluoro acryl-silicon resin, the pigment particles and the additive into the solvent thereby forming a mixture; finally, stirring and mixing the mixture thereby obtaining gloss paint.

The stirring and mixing can be performed by, for example, mechanical stirring, electromagnetic stirring or ultrasonic agitation. In the preferred embodiment, the stirring and mixing is performed by mechanical stirring. The time period of the stirring and mixing can be in the range from several hours to 24 hours depending on the content of the paint.

The method for forming a gloss paint layer on a surface of an article is explained in detail below.

At first, the above gloss paint is provided. Then, the gloss paint is applied onto the surface of the article. Finally, the gloss paint is heated so as to evaporate the solvent, thereby forming the gloss paint layer on the surface of the article. The step of applying the gloss paint may be performed, for example, by spraying. Preferably, the gloss paint layer is heated to a temperature in the range from 60 to 80 degrees centigrade, and the heating last for a time period in the range from 0.5 hours to 3 hours. In addition, the article may be a plastic, such as ABS (acrylonitrile-butadiene-styrene), PC (polycarbonate), PET (Poly ethylene terephthalate), or PVC (Poly vinyl chloride).

During the step of heating, side chains of fluorin and silicon in the fluoro acryl-silicon resin will tend to transfer or turn to a top surface of the paint layer, thus transporting the pigment particles to a bottom of the paint layer. Consequently, the top surface of the painter layer can thus have a high gloss finish.

Further, using a 60° glossmeter to measure the gloss of the paint layer, the gloss thereof is generally in the range from 95 to 100 GU (gloss units). Commonly, if only the gloss of a layer is larger than 80 GU, the layer can be regarded as having a high gloss finish. That is, without assistance of a top coat, the present paint layer may have a high gloss finish. Therefore using the present gloss paint to obtain the high gloss paint layer economizes on equipment and simplifies use.

Furthermore, according to an aspect of the embodiment, by controlling the thickness of the paint layer, the paint layer may obtain various properties. For example, when a thickness of the paint layer is in the range from 40 micrometers to 50 micrometers, the paint layer has high gloss and mirror reflection; when the thickness of the painter layer is in the range from 20 micrometers to 40 micrometers, the paint layer has properties of high gloss but little mirror reflection.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. A gloss paint comprising:
a fluoro acryl-silicon resin in an amount by weight from 20% to 60%;
a plurality of pigment particles in an amount by weight from 5% to 40%;
an additive in an amount by weight of less than 5%; and
the remainder being a solvent.

2. The gloss paint as described in claim 1, wherein the fluoro acryl-silicon resin is represented by following formula: 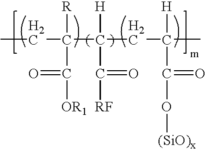
wherein R and R₁ are C1-C4 alkyl, x is in the range from 1 to 3, and m is in the range from 83 to 277.

3. The gloss paint as described in claim 1, wherein an average diameter of the pigment particles is in the range from about 10 to 500 nanometers.

4. The gloss paint as described in claim 1, wherein the additive is selected from the group consisting of hardening agents, anti-skinning agents, plasticizers, and any combination thereof.

5. The gloss paint as described in claim 4, wherein the hardening agent is toluene diisocyanate.

6. The gloss paint as described in claim 1, wherein the solvent is selected from the group consisting of dimethylbenzene, methyl ethyl ketone, methyl isobutyl ketone, and any combination of these compounds.

7. A method for forming a gloss paint layer on a surface of an article, the method comprising the steps of:
providing the gloss paint, which comprises a fluoro acryl-silicon resin in an amount by weight from 20% to 60%; a plurality of pigment particles in an amount by weight from 5% to 40%; an additive in an amount by weight of less than 5%; the remainder being a solvent;
applying the gloss paint on the surface of the article; and
heating the gloss paint so as to evaporate the solvent, thereby forming the gloss paint layer on the surface of the article.

8. The method as described in claim 7, wherein the gloss paint is applied on the surface of the article by spraying.

9. The method as described in claim 7, wherein the step of heating is performed at a temperature in the range from 60 to 80 degrees centigrade.

10. The method as described in claim 7, wherein the step of the heating is performed for a time period of 0.5 hours to 3 hours.

11. The method as described in claim 7, wherein the thickness of the paint layer is in the range from 20 micrometers to 40 micrometers.

12. The method as described in claim 7, wherein the thickness of the paint layer is in the range from 40 micrometers to 50 micrometers.
